(19) United States
(12) Patent Application Publication
(10) Pub. No.: US 2016/0366026 A1
(43) Pub. Date: Dec. 15, 2016

(54) TECHNOLOGIES FOR CLOUD DATA CENTER ANALYTICS

(71) Applicant: INTEL CORPORATION, Santa Clara, CA (US)

(72) Inventors: Katalin K. BARTFAI-WALCOTT, El Dorado Hills, CA (US); Alexander LECKEY, Kilcock (IE); Thijs METSCH, Koln (DE); Joseph BUTLER, Stamullen Co. Meath (IE); Slawomir PUTYRSKI, Gdynia (PL); Connor UPTON, Leixlip (IE); Giovani ESTRADA, Dublin (IE); John KENNEDY, Clane (IE)

(21) Appl. No.: 15/114,696

(22) PCT Filed: Feb. 24, 2015
(86) PCT No.: PCT/US2015/017223

§ 371 Date: Jul. 27, 2016

Related U.S. Application Data
(60) Provisional application No. 61/946,161, filed on Feb. 28, 2014.

(51) Int. Cl. H04L 12/24; H04L 12/26

(52) U.S. Cl. CPC H04L 41/145; H04L 41/0836; H04L 43/04; H04L 41/0816; H04L 67/1031

(57) ABSTRACT

Technologies for generating an analytical model for a workload of a data center include an analytics server to receive raw data from components of a data center. The analytics server retrieves a workbook that includes analytical algorithms from a workbook marketplace server, and uses the analytical algorithms to analyze the raw data to generate the analytical model for the workload based on the raw data. The analytics server further generates an optimization trigger to be transmitted to a controller component of the data center that may be based on the analytical model and one or more previously generated analytical models. The workbook marketplace server may include a plurality of workbooks, each of which may include one or more analytical algorithms from which to generate a different analytical model for the workload of the data center.

### CROSS-REFERENCE TO RELATED APPLICATIONS

The present application claims priority under 35 U.S.C. §119(e) to U.S. Provisional Patent Application Ser. No. 61/946,161, entitled “CLOUD DATA CENTER ANALYTICS,” which was filed on Feb. 28, 2014.

### BACKGROUND

“Cloud” computing often refers to the provisioning of computing resources as a service, usually by a number of computer servers that are networked together at a location remote from the location from which the services are requested. A cloud data center typically refers to the physical arrangement of servers that make up a cloud or a particular portion of a cloud. For example, servers can be physically arranged in the data center into rooms, groups, rows, and racks. A data center may have one or more “zones,” which may include one or more rooms of servers. Each room may have one or more rows of servers, and each row may include one or more racks. Each rack may include one or more individual server nodes. Servers in zones, rooms, racks, and/or rows may be arranged into virtual groups based on physical infrastructure requirements of the data center facility, which may include power, energy, thermal, heat, and/or other requirements.

Notwithstanding its physical location within a data center, a server or portions of its resources may be allocated (e.g., for use by different customers of the data center) according to actual or anticipated use requirements, such as security, quality of service, throughput, processing capacity, and/or other criteria. As an example, one customer's computing workload may be divided among multiple physical servers (which may be located in different rows, racks, groups, or rooms of the data center), or among multiple nodes or resources on the same server, using virtualization. Thus, in the context of virtualization, servers can be grouped logically to satisfy workload requirements.

Efficiently managing cloud data centers has become increasingly difficult in view of the complex configurations being implemented in cloud data centers today. A major factor contributing to this difficulty is an abundance of operational data generated by each device and/or service making up the data center. Due to the sheer volume of such data, it is often difficult for data center administrators to get an overall view of the health, performance, or even layout of their data centers in real-time. As a result, decisions impacting the overall health, performance, and layout of data centers are often made based on stale or incomplete information.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for generating an analytical model for a data center;

FIG. 2 is a simplified block diagram of at least one embodiment of an analytics server of the system of FIG. 1;

FIG. 3 is a simplified flow diagram of at least one embodiment of a method for generating an analytical model for a data center that may be executed by the analytics server of the system of FIG. 1; and

FIG. 4 is a simplified block diagram of at least one embodiment of a workbook user interface that may be used to initiate the method of FIG. 3.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

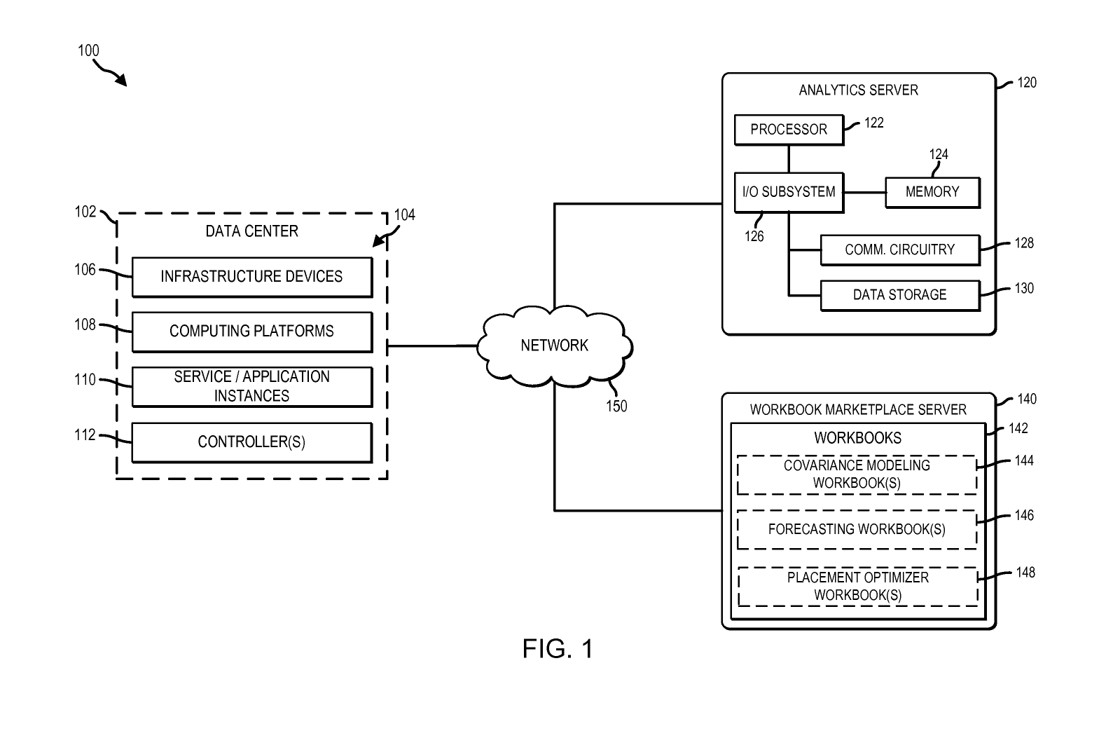

Referring now to FIG. 1, in an illustrative embodiment, a system 100 for generating analytical models for a data center includes a data center 102, an analytics server 120, and a workbook marketplace server 140, which communicate with each other over a network 150. Illustratively, the data center 102 is embodied as a highly heterogeneous data center environment including any number of components 104 (e.g., computing devices, networking devices, server devices, storage devices, computing services, applications, services, etc.). In use, as will be described in further detail, the analytics server 120 may receive raw data (e.g., operational data, infrastructure data, application data, service data, etc.) for analysis from one or more of the components 104 of the data center 102. A number of analytical models may be generated by the analytics server 120 based on the received raw data for a given workload (i.e., a network workload that may be differentiated by flow, type, application association, classification, requirements, etc.), which may be used to determine and generate one or more optimization triggers to be transmitted and processed by a component 104 the data center 102, such as the controller 112. To do so, the analytics server 120 may execute (e.g., launch, process, initialize, etc.) one or more analytical algorithms, organized into workbooks 142, which may be stored in and retrieved from the workbook marketplace server 140.

In some embodiments, the analytics server 120, running as a standalone entity (i.e., not locked to a particular controller or orchestration solution), may retrieve one or more workbooks 142 from the workbook marketplace server 140 by way of purchase from the workbook marketplace server 140, such as for a fee and/or provided to an administrator based on a type of subscription plan. Each of the workbooks 142 may include a different analytical algorithm and/or set of analytical algorithms configured to generate a different analytical model for determining different optimization triggers based on the raw data received. In that way, an administrator of the data center 102 may be provided with an option to obtain different (i.e., alternative) workbooks 142 based on the topology of the data center 102 and/or type or format of analytical model that is desired to be generated. The analytics server 120 is configured to generate an analytical model for a given workload based on the executed analytical algorithm(s) of a retrieved workbook 142. The analytics server 120 may then compare the analytical model against previous analytical models generated for that same workload, query the underlying infrastructure landscape that the workload is deployed on for comparison to historical infrastructure landscape deployments, and identify optimizations for the data center 102 based on the comparisons.

While conventional orchestration software only monitors data available from its own system (i.e., operates on an incomplete view of the infrastructure platform), the analytics server 120, running as a standalone entity, can process data from multiple instrumentation sources, providing an overall perspective of the entire infrastructure platform. Accordingly, different performance indicators of the data center 102 relating to placement, execution, and measurement of the components 104 may be mapped by the analytics server 120 to an information model (i.e., the underlying infrastructure landscape) of the physical and virtualized components 104 within the data center 102. The information model, including metadata and dependencies of the components 104 of the data center 102, may be analyzed by the analytics server 120 to identify optimization triggers based on the workbooks 142 selected on which to perform the analysis.

Such optimization triggers may be utilized by an administrator of the data center 102 to cause a change to the configuration, performance levels, workload requirements, or any other aspect of one or more components 104 of the data center 102. For example, the administrator may select one or more of the workbooks 142 to analyze the performance of service stacks running on the underlying infrastructure landscape, which may allow the administrator of the data center 102 to achieve a more precise placement and scheduling of services over time based on the analytical model(s) generated for each workbook and/or the optimization triggers generated therefrom. Such precise placement and scheduling of services may allow the administrator to maintain compliance within service level objectives (SLOs) that may be specified in service level agreements (SLAs), for example. As such, the workbooks 142 obtained and executed by the administrator may be selected and/or modified based on such service level objectives.

The data center 102 may be embodied as a traditional data center, computing cluster, or other collection of computing machines. For example, the system 100 may include any number of components 104 (e.g., rack-mounted compute nodes, freestanding compute nodes, and/or virtual compute nodes) in communication over a network, a network switching fabric, a storage area network, a cloud controller, or other typical datacenter components. It should be appreciated that the components 104 of the data center 102 may be embodied as any type of hardware component, software component, processing environment, runtime application/service instance, and/or any other type of component.

For example, in some embodiments, the data center 102 may include one or more infrastructure-level components 106 (e.g., physical servers, virtual servers, storage area network components, network components, etc.). The data center 102 may also include one or more platform-level and/or runtime-level components 108 (e.g., software platforms, a process virtual machine, a managed runtime environment, middleware, a platform as a service, etc.). Additionally or alternatively, in some embodiments, the data center 102 may include one or more instances of a service-level and/or application-level component 110 (e.g., number of connected users, running threads, http connections, etc.).

In some embodiments, the data center 102 may additionally include one or more controllers 112. The controllers 112 may be embodied as any computing nodes or other computing devices capable of performing workload management and orchestration functions for at least a portion of the data center 102 and the functions described herein. For example, the controllers 112 may be embodied as one or more computer servers, embedded computing devices, managed network devices, managed switches, or other computation devices. In some embodiments, the controller 112 may be embodied as a software-defined networking (SDN) controller and/or a network functions virtualization (NFV) manager and network orchestrator (MANO). The controllers 112 may select which components 104 of the data center 102 are to execute certain applications and/or services based on certain criteria, such as available resources, proximity, security, and/or other criteria. Additionally, in some embodiments, after selecting the components 104, the controller 112, or orchestrator, of the data center 102 may create or otherwise initialize execution of the applications and/or services using the selected components 104. The one or more components 104 of the data center 102 may be configured to collectively process a customer workload or they may be configured to individually process different customer workloads. As such, the data center 102 may include devices and structures commonly found in data centers, which are not shown in FIG. 1 for clarity of the description.

The analytics server 120 may be embodied as, or otherwise include, any type of computing device capable of performing the functions described herein including, but not limited to a server computer, a desktop computer, a laptop computing device, a home automation gateway device, a programmable logic controller, a smart appliance, a consumer electronic device, a wireless access point, a network switch, a network router, a mobile computing device, a mobile phone, a smart phone, a tablet computing device, a personal digital assistant, a wearable computing device, and/or other type of computing device. The illustrative analytics server 120 includes a processor 122, a memory 124, an input/output (I/O) subsystem 126, communication circuitry 128, and a data storage 130. Of course, the analytics server 120 may include other or additional components, such as those commonly found in a server computing device (e.g., various input/output devices), in other embodiments. Additionally, in some embodiments, one or more of the illustrative components may be incorporated in, or otherwise from a portion of, another component. For example, the memory 124, or portions thereof, may be incorporated in the processor 122 in some embodiments.

The processor 122 may be embodied as any type of processor capable of performing the functions described herein. For example, the processor 122 may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the analytics server 120, such as operating systems, applications, programs, libraries, and drivers. The memory 124 is communicatively coupled to the processor 122 via the I/O subsystem 126, which may be embodied as circuitry and/or components to facilitate input/output operations with the processor 122, the memory 124, and other components of the analytics server 120. For example, the I/O subsystem 126 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 126 may form a portion of a system-on-a-chip (SoC) and be incorporated, along with the processor 122, the memory 124, and other components of the analytics server 120, on a single integrated circuit chip.

The communication circuitry 128 of the analytics server 120 may be embodied as any type of communication circuit, device, or collection thereof, capable of enabling communications between the analytics server 120 and the component(s) 104 of the data center 102, the workbook marketplace server 140, and/or other computing devices. The communication circuitry 128 may be configured to use any one or more communication technologies (e.g., wireless or wired communications) and associated protocols (e.g., Ethernet, Wi-Fi®, WiMAX, etc.) to affect such communication.

The data storage 130 may be embodied as any type of device or devices configured for short-term or long-term storage of data such as, for example, memory devices and circuits, memory cards, hard disk drives, solid-state drives, or other data storage devices. For example, the data storage 130 may be configured to store one or more operating systems to be initialized and/or executed by the analytics server 120. In some embodiments, portions of the operating system(s) may be copied to the memory 124 during operations for faster processing and/or any other reason.

As discussed above, the analytics server 120 may communicate with one or more components 104 of the data center 102 and the workbook marketplace server 140 over the network 150. The network 150 may be embodied as any number of various wired and/or wireless communication networks. For example, the network 150 may be embodied as or otherwise include a local area network (LAN), a personal area network (PAN), a wide area network (WAN), a cellular network, and/or a publicly-accessible, global network such as the Internet. Additionally, the network 150 may include any number of additional devices to facilitate communication between the analytics server 120, the component(s) 104 of the data center 102, the workbook marketplace server 140, and other devices of the system 100.

The workbook marketplace server 140 may be embodied as any type of server or similar computing device or devices capable of storing the workbooks 142 and performing the functions described herein. As such, the workbook marketplace server 140 may include devices and structures commonly found in servers, such as processors, memory devices, communication circuitry, and data storages, which are not shown in FIG. 1 for clarity of the description. While the illustrative workbook marketplace server 140 is depicted as a single server, it should be appreciated that, in some embodiments, the workbook marketplace server 140 may be comprised of any number of server, storage, and/or compute devices, such as in a distributed computing system, capable of performing the functions described herein.

As discussed in more detail below, the workbook marketplace server 140 is configured to provide workbooks 142 to the analytics server 120 upon request, such as by an administrator or user of the data center 102. As such, the workbook marketplace server 140 may include any number of different workbooks 142 available for request at runtime. Each workbook 142 may include one or more analytical algorithms configured or otherwise adapted to generate a different analytical model for a data center 102 based on the raw data received. Additionally or alternatively, each workbook 142 may include one or more analytical algorithms configured or otherwise adapted to generate a different optimization trigger or provide an overall visualization of the data center 102 based on the received raw data. As such, each workbook 142 may serve a different purpose for the administrator.

In some embodiments, the workbook marketplace server 140 may include various types of workbooks 142, such as one or more covariance modeling workbooks 144 (e.g., a covariance time series workbook), one or more forecasting workbooks 146, and/or one or more placement optimizer workbooks 148. It should be appreciated that the workbook marketplace server 140 may include additional or alternative types of workbooks 142, such as graph comparison workbooks, anomaly detection workbooks, failure prediction workbooks, and/or any other such workbook types that may be applicable to analyze one or more features and/or components 104 of the data center 102. Since each workbook 142 processes the raw data according to a particular analytical algorithm, or a particular set of analytical algorithms, each workbook 142 can produce different analytical models, and therefore different optimization triggers, which an administrator of the data center 102 may use for comparison purposes before implementing changes based on a particular optimization trigger. Further, in some embodiments, the workbooks 142 may be atomic, standalone scripts that may be long-running for continuous analytics tasks.

The covariance modeling workbooks 144 (e.g., a covariance time series workbook) may be configured to generate a covariance model of the data center 102 and/or components 104 of the data center 102 based on raw data analyzed by the covariance modeling workbook 144. For example, a covariance time series workbook may review two sets of time series data and check for a covariance between them. Accordingly, based on a correlation scalar (between 0 and 1), it may be determined which time series correlate, and which time series do not. As such, the time series determined to correlate may be clustered in order to make decisions based on the cluster, which may produce metrics indicating how each time series influences the other time series.

The forecasting workbooks 146 may be configured to forecast future demands on the data center 102 based on the raw data analyzed by the forecasting workbooks 146. Such information may then be used by administrators and/or system architects for planning for future growth of the data center 102 and/or predicting increased customer workloads. Accordingly, the administrators and/or system architects may alter (i.e., add, remove, adjust, etc.) one or more of the components 104 of the data center 102 based on the projected future demands on the data center 102.

The placement optimizer workbooks 148 may be configured to determine an optimal set of components 104 of the data center 102 for performing a particular service or application. For example, a placement optimizer workbook 148 may retrieve two graphs representative of the physical and/or virtual landscape that a targeted service instance is presently deployed (i.e., running) on. Each graph may contain all of the components 104 of the running service instance including virtual machines, physical hosts, virtual networks, and/or additional services and/or applications presently running on one or more of the components 104. Based on the raw data received to be processed (i.e., analyzed), the placement optimizer workbook 148 may determine which of the two graphs is performing at a more optimal efficiency based on certain criteria, such as CPU instructions per cycle, memory cache efficiency (i.e., hits/misses), network latency, etc. Accordingly, the graph determined to be performing at the more optimal efficiency may be transformed accordingly. In some embodiments, the transformation may be done by editing a particular portion, or section, of code. For example, a template defining a collection of components 104 for executing a particular service or application, such as an orchestration template of an automated orchestration service (e.g., OpenStack Heat), may be modified based on the results of the graph determined to be performing at the more optimal efficiency by the placement optimizer workbook 148.

In some embodiments, the workbook marketplace server 140 may automatically generate and/or enrich (e.g., update, refresh, enhance, revise, etc.) one or more of the workbooks 142 (or the analytical algorithms included therein) based on raw data received from multiple different sources. For example, in some embodiments, the workbook marketplace server 140 may receive raw data from many different components 104 from many different data centers 102. In such embodiments, the workbook marketplace server 140 may be configured to analyze the received raw data using machine learning (or any other suitable learning or analysis process) to determine trends and or statistically relevant data. Based on such an analysis, the workbook marketplace server 140 may generate a new workbook and/or update an existing workbook. Additionally or alternatively, in some embodiments, an administrator may add, remove, and/or modify one or more of the workbooks 142 based on the specific needs of one or more data centers 102.

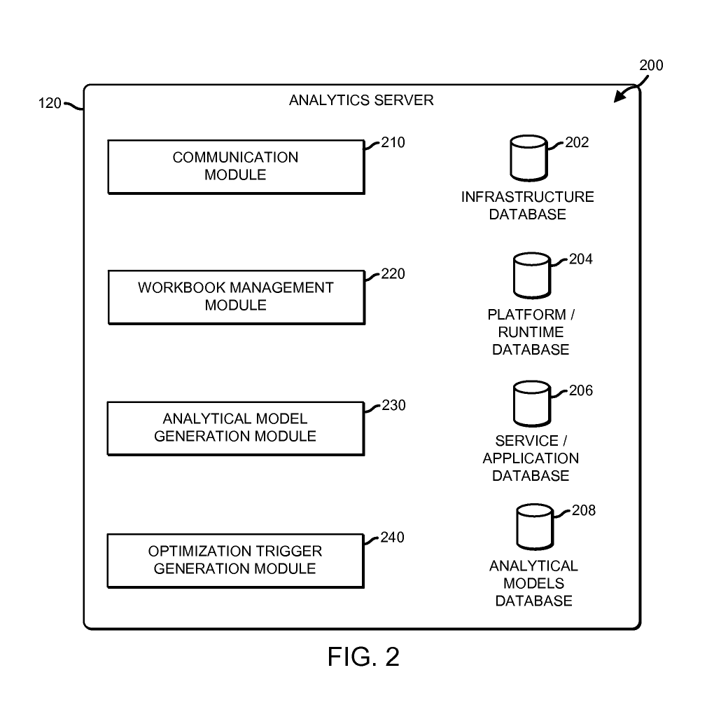

Referring now to FIG. 2, in use, the analytics server 120 establishes an environment 200 during operation. The illustrative environment 200 includes a communication module 210, a workbook management module 220, an analytical model generation module 230, and an optimization trigger generation module 240. Each of the modules, logic, and other components of the environment 200 may be embodied as hardware, software, firmware, or a combination thereof. For example, each of the modules, logic, and other components of the environment 200 may form a portion of, or otherwise be established by, a processor or other hardware components of the analytics server 120. As such, in some embodiments, one or more of the modules of the environment 200 may be embodied as a circuit or collection of electrical devices (e.g., an analytical model generation circuit, an optimization trigger generation circuit, etc.). In the illustrative environment 200, the analytics server 120 includes an infrastructure database 202, a platform/runtime database 204, a service/application database 206, and an analytical models database 208, each of which are accessible by the various modules of the analytics server 120. It should be appreciated that the analytics server 120 may include other components, sub-components, modules, and devices commonly found in a server device, which are not illustrated in FIG. 2 for clarity of the description.

The communication module 210 of the analytics server 120 facilitates communications between components or sub-components of the analytics server 120 and the component(s) 104 of the data center 102 and/or the workbook marketplace server 140. For example, in some embodiments, the communication module 210 may facilitate receiving raw data from one or more of the components 104 of the data center 102. The communication module 210 may also facilitate transmitting one or more optimization triggers to the component(s) 104 of the data center 102, such as the controllers 112. In some embodiments, the communication module 210 may also facilitate the request for and/or receipt of one or more workbooks 142 from the workbook marketplace server 140.

The analytical model generation module 230 may be configured to generate an analytical model for the data center 102 based on the raw data received from the component(s) 104 of the data center 102 for a given workload. To do so, the analytical model generation module 230 may be configured to execute (e.g., launch, process, initialize, etc.) one or more analytical algorithms that have been loaded into the memory 124 of the analytics server 120 and executed in the background. As described above, the analytical algorithms may be included in a workbook 142 retrieved from the workbook marketplace server 140 at runtime. In some embodiments, the analytical model generation module 230 may be configured to load the raw data as a continuous stream or as a bulk upload. Upon loading the raw data, the analytical model generation module 230 may receive a workbook 142 from the workbook marketplace server 140 via the workbook management module 220, for example. After receiving the workbook 142, the analytical model generation module 230 may then analyze the raw data using the received workbook 142 and output an analytical model based on the raw data analysis. In some embodiments, a cloud scheduler may coordinate the workbooks 142 to be completed in proximity to the raw data to be received and analyzed by the analytical model generation module 230.

As described above, in some embodiments, the analytical algorithms of the workbooks 142 may generate various data models of the data center 102 as a whole, or of one or more of the components 104 of the data center 102, based on the received raw data and a given workload. The received raw data may include raw data corresponding to infrastructure instrumentation, which may be stored in the infrastructure database 202. The raw data corresponding to the infrastructure instrumentation may include various supplies system metrics (e.g., system utilization, per core or per socket, etc.), hardware performance counters (e.g., CPU performance counters, resource utilization counters, network traffic counters, etc.), and/or environment attributes (e.g., temperature, power consumption, etc.). The received raw data may additionally or alternatively include raw data corresponding to platform/runtime instrumentation, which may be stored in the platform/runtime database 204. The raw data corresponding to the platform/runtime instrumentation may include various network attributes, such as a number of connected users, executing threads, hyper-text transfer protocol (HTTP) connections, etc. The received raw data may additionally or alternatively include raw data corresponding to service/application instrumentation, which may be stored in the service/application database 206. The raw data corresponding to the service/application instrumentation may include various application performance indicators, such as buffer lengths, queue lengths, queue wait time for compute devices (e.g., physical and/or virtual servers), storage devices (e.g., a storage area network (SAN)), and/or network devices (e.g., switches, routers, internet connections, and the like).

In some embodiments, the analytical model generation module 230 may be configured as an analytics engine that includes a software development kit (SDK) (i.e., set of software development tools) for querying the raw data from the components 104 of the data center 102, such as via the communication module 210. Additionally, in some embodiments, the SDK may include various routines for analyzing (e.g., comparing) and/or optimizing (e.g., placing) graphs, interfacing with service templates, and triggering updates to the controllers 112, or orchestrators, such as via the optimization trigger generation module 240.

The optimization trigger generation module 240 may be configured to generate one or more optimization triggers for the data center 102 based on a comparison between analytical models for a given workload, such as those analytical models generated by the analytical model generation model 230, as described above, and historical analytical models generated for the same workload, which may be stored in the analytical models database 208. In some embodiments, the analytical models database 208 may additionally include an infrastructure landscape corresponding to the components 104 of the data center 102 that the given workload is deployed on. The optimization trigger generation module 240 may determine one or more changes that should be made to the data center 102 and/or one or more components 104 of the data center 102 based on the analytical models generated for the selected workbook 142. The optimization trigger generation module 240 may additionally or alternatively generate the optimization triggers based on a historical analysis of the previously generated analytical models generated for the selected workbook 142 for the given workload and/or the previous infrastructure landscapes the given workload was deployed on. Such optimization triggers may be transmitted via the communication module 210 to one or more components 104 of the data center 102, such as one or more of the controllers 112, to cause a change to the configuration, performance levels, workload requirements, or any other aspect of the data center 102 or a component 104 of the data center 102.

The optimization triggers include a recommended action based on the layer in which the optimization resides. For example, the recommended actions may include various infrastructure changes, platform/runtime changes, and/or application/service changes. The infrastructure changes may include the placement of virtual machines, core binding, data aware scheduling, usage rate limiting/capping of resources, and/or reconfiguration of SDNs and/or NFVs. The platform/runtime changes may include platform reconfiguration, such as increasing memory heap size, for example. The application/service changes may include the configuration, or reconfiguration, of rate limits, new users, etc. applicable to a particular application or service. In some embodiments, the optimization triggers may be transmitted to the controller 112, or orchestrators, through an application program interface (API), such as OpenStack's Heat API or the Open Cloud Computing Interface (OCCI) API, for example.

The workbook management module 220 may be configured to retrieve and/or receive one or more workbooks from the workbook marketplace server 140. Each workbook may include a different analytical algorithm and/or set of analytical algorithms configured to generate a different analytical model or different optimization triggers based on the raw data received. In some embodiments, the workbook management module 220 may be configured to retrieve the one or more workbooks from the workbook marketplace server 140 after payment of a fee or subsequent to successful enrollment in a subscription plan. In such embodiments, the workbook management module 220 may be configured to facilitate payment of any required fees for a workbook and/or a corresponding subscription plan.

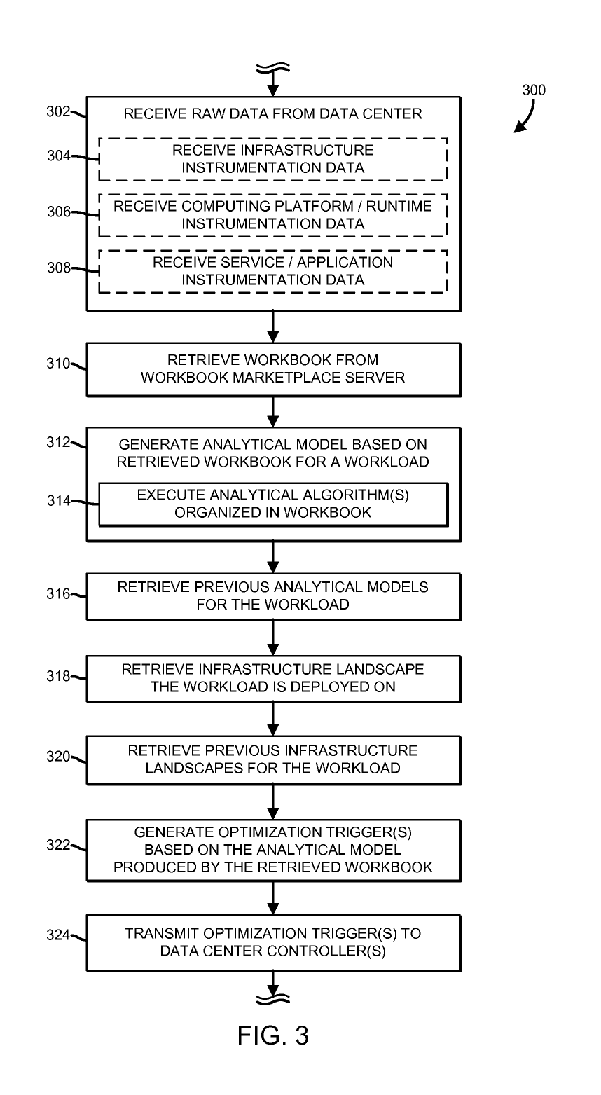

Referring now to FIG. 3, in use, the analytics server 120 may execute a method 300 for generating an analytical model for the data center 102. The method 300 begins with block 302 in which the analytics server 120 receives raw data from one or more components 104 of the data center 102 for analysis. For example, in block 304, the analytics server 120 may receive infrastructure instrumentation data from the component(s) 104 of the data center 102. In some embodiments, the infrastructure instrumentation data may be indicative any type of operational information, characteristic information, feature information, attribute information, and/or parameters associated with an infrastructure-level component 106 of the data center 102 (e.g., physical servers, virtual servers, storage area network components, network components, etc.). Additionally or alternatively, in block 306, the analytics server 120 may receive computing platform instrumentation data from the component(s) 104 of the data center 102.

The platform instrumentation data may be indicative any platform-level and/or runtime-level component 108 of the data center 102 (e.g., software platforms, a process virtual machine, a managed runtime environment, middleware, a platform as a service (PaaS), etc.). In some embodiments, in block 308, the analytics server 120 may receive service/application instance instrumentation data from the component(s) 104 of the data center 102. The service/application instance instrumentation data may be indicative any instance of a service-level and/or application-level component 110 of the data center 102 (e.g., a number of connected users, a number of running threads, a number of HTTP connections, etc.). It should be appreciated that in some embodiments the infrastructure instrumentation data, computing platform instrumentation data, and service/application instance instrumentation data may be associated with application performance and/or data center 102 workload performance (e.g., buffer lengths, queue lengths, etc.).

In block 310, the analytics server 120 retrieves a workbook 142 from the workbook marketplace server 140. As discussed, the workbook marketplace server 140 may include any number of different workbooks 142. Each workbook 142 may include a different analytical algorithm and/or set of analytical algorithms configured to generate a different analytical model or different optimization triggers based on the data center 102 and the raw data received.

In block 312, the analytics server 120 generates an analytical model for at least a portion of the data center 102 for the retrieved workbook 142 based on the raw data received from the component(s) 104 of the data center 102 and the analytical algorithms of the retrieved workbook 142 for a given workload. To do so, in block 314, the analytics server 120 executes (e.g., launches, processes, initializes, etc.) one or more analytical algorithms from the workbook 142. The analytical algorithm(s) of the workbook 142 may be configured to generate the analytical model for the data center 102 based on the received raw data for the given workload. For example, in some embodiments, the analytical algorithm(s) of the workbook 142 may generate various analytical models including, but not limited to, a covariance model, a forecasting model, and/or a placement optimization model of the data center 102 as a whole or of one or more of the components 104 of the data center 102.

In block 316, the analytics server 120 retrieves previous analytical models generated by the analytics server for the given workload. In block 318, the analytics server 120 retrieves the infrastructure landscape (i.e., one or more components 104 of the data center 102) that the given workload is deployed on. In block 320, the analytics server 120 retrieves the previous infrastructure landscapes that the given workload has been deployed on in the past when the analytics server 120 generated the previous analytical models for the given workload.

In block 322, the analytics server 120 may determine and generate one or more optimization triggers for the data center 102 based on the generated analytical model and the retrieved historical analytical models, present infrastructure landscape, and historical infrastructure landscapes. The optimization triggers may be transmitted to one or more of the components 104, such as the controllers 112, to cause a change to the configuration, performance levels, workload requirements, or any other aspect of the data center 102 or a component 104 of the data center 102.

For example, in some embodiments, the analytics server 120 may generate one or more optimization triggers configured to cause a change to one or more infrastructure device components 106 of the data center 102 (e.g., rate limiting/capping of resource usage, reconfiguration of software-defined networking/network functions virtualization, data aware scheduling, placement of virtual machines, core binding, etc.). Additionally or alternatively, the analytics server 120 may generate one or more optimization triggers configured to cause a change to one or more platform-level and/or runtime-level components 108 of the data center 102 (e.g., reconfiguring a memory heap size of a process virtual machine or a managed runtime environment, etc.). The analytics server 120 may also generate one or more optimization triggers configured to cause a change to one or more instances of a service-level and/or application-level component 110 of the data center 102 (e.g., configure new rate limits, add new users, etc.). It should also be appreciated that analytics server 120 may also generate one or more optimization triggers configured to cause one or more components 104 of the data center 102 to change a configuration, setting, and/or rule associated with the scheduling and placement of workloads, components 104, and/or resources at runtime (e.g., realistic indicators of resource elements and combinations across various I/O configurations, etc.). Subsequently, in block 324, the analytics server 120 may transmit the generated optimization trigger(s) to the data center 102 and/or one or more components 104 of the data center 102, such as the controllers 112, for further processing (e.g., execution or triggering of corresponding function, etc.) and or action to be taken thereon. In some embodiments, the optimization trigger(s) may be transmitted in a format such that the controllers 112 can make automated changes to one or more components 104 of the data center 102 in response to the optimization trigger(s).

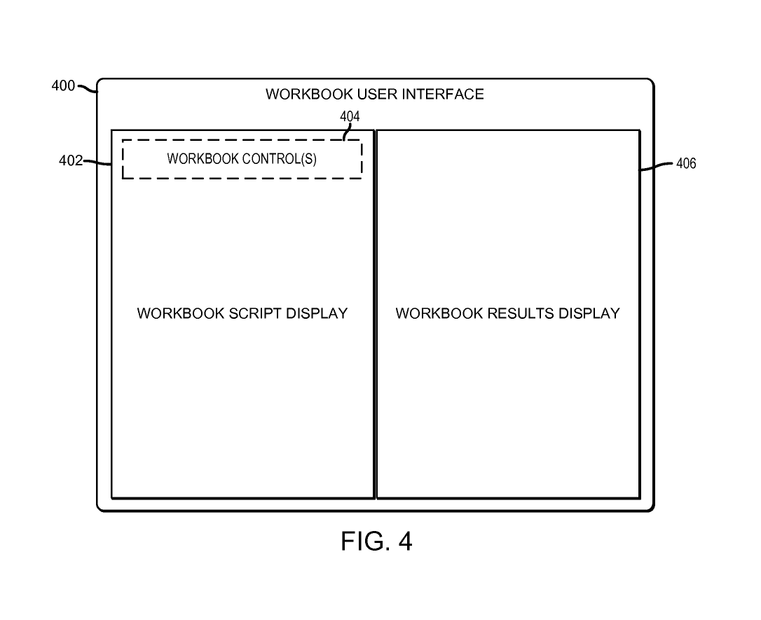

Referring now to FIG. 4, a workbook user interface 400 that may be used to select a workbook and generate an analytical model for the data center 102 includes a workbook script display 402 and a workbook results display 406. The workbook script display 402 may be configured to display script code (i.e., source code implementation of an analytical algorithm) of a workbook 142 on least a portion of the workbook user interface 400. In some embodiments, the workbook script display 402 may additionally include one or more workbook controls 404. The workbook controls 404 may include user interface actionable command graphical icons (e.g., buttons) for loading a workbook 142, editing the script code of a loaded workbook 142, saving the edited script code of the loaded workbook 142, and/or running the loaded workbook 142. Alternatively, in some embodiments, one or more of the workbook controls 404 may be located in an alternative portion of the workbook script display 402.

The workbook results display 406 may be configured to display an analytical model (i.e., output of the execution of the workbook 142) on least a portion of the workbook user interface 400. In some embodiments, the workbook results display 406 may include, but is not limited to, various graphs, charts, plots, and recommended optimizations based on the workbook 142 loaded and run (i.e., executed) from the workbook script display 402.

In the illustrative workbook user interface, the workbook script display 402 is located at a left portion of the workbook user interface 400 and the workbook results display 406 is located at a right portion of the workbook user interface 400; however, it should be appreciated that the workbook script display 402 and the workbook results display 406 may be displayed in an alternative configuration and/or format, including tabbed, tiled, cascading, overlapping, etc.

### EXAMPLES

Illustrative examples of the technologies disclosed herein are provided below. An embodiment of the technologies may include any one or more, and any combination of, the examples described below.

Example 1 includes an analytics server to generate an analytical model for a workload of a data center, the analytics server comprising a communication module to receive raw data of one or more components of the data center and a workbook that includes one or more analytical algorithms; an analytical model generation module to analyze the raw data based on the one or more analytical algorithms of the workbook and generate an analytical model for the workload based on the analysis of the raw data; and an optimization trigger generation module to generate an optimization trigger for one or more components of the data center based on the analytical model and one or more previously generated analytical models.

Example 2 includes the subject matter of Example 1, and further including a workbook management module to receive the workbook from a workbook marketplace server, wherein the workbook marketplace server comprises a plurality of workbooks and each of the plurality of workbooks includes one or more different analytical algorithms.

Example 3 includes the subject matter of any of Examples 1 and 2, and wherein the analytical model generation module is further to generate different analytical models for the data center based on the different analytical algorithms and the workload.

Example 4 includes the subject matter of any of Examples 1-3, and wherein the optimization trigger generation module is to generate the optimization trigger for the data center further based on the different analytical models.

Example 5 includes the subject matter of any of Examples 1-4, and wherein the raw data received by the communication module comprises raw data received from one or more instrumentation-level components of the data center.

Example 6 includes the subject matter of any of Examples 1-5, and wherein the one or more instrumentation-level components comprises an infrastructure instrumentation level.

Example 7 includes the subject matter of any of Examples 1-6, and wherein the one or more instrumentation-level components comprises a platform instrumentation level.

Example 8 includes the subject matter of any of Examples 1-7, and wherein the one or more instrumentation-level components comprises a service instrumentation level or an application instrumentation level.

Example 9 includes the subject matter of any of Examples 1-8, and wherein the communication module is further to transmit the optimization trigger to a controller component of the data center.

Example 10 includes the subject matter of any of Examples 1-9, and wherein the communication module is further to retrieve an infrastructure landscape of the data center used to deploy the workload.

Example 11 includes the subject matter of any of Examples 1-10, and wherein the analytical model generation module is to generate the analytical model for the workload further based on the retrieved infrastructure landscape.

Example 12 includes the subject matter of any of Examples 1-11, and wherein the optimization trigger generation module is to generate the optimization trigger for the data center further based on one or more previous infrastructure landscapes used to deploy the workload.

Example 13 includes a method for generating an analytical model for a workload of a data center on an analytics server, the method comprising receiving, by the analytics server, raw data from one or more components of the data center; retrieving, by the analytics server, a workbook including one or more analytical algorithms; analyzing, by the analytics server, the raw data using the one or more analytical algorithms of the workbook; generating, by the analytics server, an analytical model for a workload based on the analysis of the raw data; generating, by the analytics server, an optimization trigger for one or more components of the data center based on the generated analytical model; and transmitting, by the analytics server, the optimization trigger to a controller component of the data center.

Example 14 includes the subject matter of Example 13, and further including retrieving, by the analytics server, an infrastructure landscape of the data center used to deploy the workload; and generating the analytical model for the workload further based on the retrieved infrastructure landscape.

Example 15 includes the subject matter of any of Examples 13 and 14, and further including retrieving, by the analytics server, one or more previous infrastructure landscapes used to deploy the workload; and generating the optimization trigger for the data center further based on the one or more previous infrastructure landscapes.

Example 16 includes the subject matter of any of Examples 13-15, and wherein retrieving the workbook comprises retrieving the workbook from a workbook marketplace server, wherein the workbook marketplace server comprises a plurality of workbooks and each of the plurality of workbooks includes one or more different analytical algorithms.

Example 17 includes the subject matter of any of Examples 13-16, and further including generating different analytical models for the data center based on the different analytical algorithms and the workload.

Example 18 includes the subject matter of any of Examples 13-17, and further including generating the optimization trigger for the data center further based on the different analytical models.

Example 19 includes the subject matter of any of Examples 13-18, and wherein receiving the raw data from the one or more components of the data center comprises receiving the raw data from one or more instrumentation-level components of the data center.

Example 20 includes the subject matter of any of Examples 13-19, and wherein receiving the raw data from one or more instrumentation-level components of the data center comprises receiving the raw data from an infrastructure instrumentation level.

Example 21 includes the subject matter of any of Examples 13-20, and wherein receiving the raw data from one or more instrumentation-level components of the data center comprises receiving the raw data from a platform instrumentation level.

Example 22 includes the subject matter of any of Examples 13-21, and wherein receiving the raw data from one or more instrumentation-level components of the data center comprises receiving the raw data from a service instrumentation level or an application instrumentation level.

Example 23 includes a computing device comprising a processor; and a memory having stored therein a plurality of instructions that when executed by the processor cause the computing device to perform the method of any of Examples 13-22.

Example 24 includes one or more machine readable storage media comprising a plurality of instructions stored thereon that in response to being executed result in a computing device performing the method of any of Examples 13-22.

Example 25 includes an analytics server for generating an analytical model for a workload of a data center on an analytics server, the analytics server comprising means for receiving, by the analytics server, raw data from one or more components of the data center; means for retrieving, by the analytics server, a workbook including one or more analytical algorithms; means for analyzing, by the analytics server, the raw data using the one or more analytical algorithms of the workbook; means for generating, by the analytics server, an analytical model for a workload based on the analysis of the raw data; means for generating, by the analytics server, an optimization trigger for one or more components of the data center based on the generated analytical model; and means for transmitting, by the analytics server, the optimization trigger to a controller component of the data center.

Example 26 includes the subject matter of Example 25, and further including means for retrieving, by the analytics server, an infrastructure landscape of the data center used to deploy the workload; and means for generating the analytical model for the workload further based on the retrieved infrastructure landscape.

Example 27 includes the subject matter of any of Examples 25 and 26, and further including means for retrieving, by the analytics server, one or more previous infrastructure landscapes used to deploy the workload; and means for generating the optimization trigger for the data center further based on the one or more previous infrastructure landscapes.

Example 28 includes the subject matter of any of Examples 25-27, and wherein the means for retrieving the workbook comprises means for retrieving the workbook from a workbook marketplace server, wherein the workbook marketplace server comprises a plurality of workbooks and each of the plurality of workbooks includes one or more different analytical algorithms.

Example 29 includes the subject matter of any of Examples 25-28, and further including means for generating different analytical models for the data center based on the different analytical algorithms and the workload.

Example 30 includes the subject matter of any of Examples 25-29, and further including means for generating the optimization trigger for the data center further based on the different analytical models.

Example 31 includes the subject matter of any of Examples 25-30, and, wherein the means for receiving the raw data from the one or more components of the data center comprises means for receiving the raw data from one or more instrumentation-level components of the data center.

Example 32 includes the subject matter of any of Examples 25-31, and wherein the means for receiving the raw data from one or more instrumentation-level components of the data center comprises means for receiving the raw data from an infrastructure instrumentation level.

Example 33 includes the subject matter of any of Examples 25-32, and wherein the means for receiving the raw data from one or more instrumentation-level components of the data center comprises means for receiving the raw data from a platform instrumentation level.

Example 34 includes the subject matter of any of Examples 25-33, and wherein the means for receiving the raw data from one or more instrumentation-level components of the data center comprises means for receiving the raw data from a service instrumentation level or an application instrumentation level.

1-25. (canceled)

26. An analytics server to generate an analytical model for a workload of a data center, the analytics server comprising:
a communication module to receive raw data of one or more components of the data center and retrieve a workbook that includes one or more analytical algorithms;
an analytical model generation module to analyze the raw data based on the one or more analytical algorithms of the workbook and generate an analytical model for the workload based on the analysis of the raw data; and
an optimization trigger generation module to generate an optimization trigger for one or more components of the data center based on the analytical model and one or more previously generated analytical models.

27. The analytics server of claim 26, further comprising a workbook management module to receive the workbook from a workbook marketplace server, wherein the workbook marketplace server comprises a plurality of workbooks and each of the plurality of workbooks includes one or more different analytical algorithms.

28. The analytics server of claim 27, wherein the analytical model generation module is further to generate different analytical models for the data center based on the different analytical algorithms and the workload.

29. The analytics server of claim 28, wherein the optimization trigger generation module is to generate the optimization trigger for the data center further based on the different analytical models.

30. The analytics server of claim 26, wherein the raw data received by the communication module comprises raw data received from one or more instrumentation-level components of the data center.

31. The analytics server of claim 30, wherein the one or more instrumentation-level components comprises a component from at least one of an infrastructure instrumentation level, a platform instrumentation level, a service instrumentation level, or an application instrumentation level.

32. The analytics server of claim 26, wherein the communication module is further to transmit the optimization trigger to a controller component of the data center.

33. The analytics server of claim 26, wherein the communication module is further to retrieve an infrastructure landscape of the data center used to deploy the workload.

34. The analytics server of claim 33, wherein the analytical model generation module is to generate the analytical model for the workload further based on the retrieved infrastructure landscape.

35. The analytics server of claim 34, wherein the optimization trigger generation module is to generate the optimization trigger for the data center further based on one or more previous infrastructure landscapes used to deploy the workload.

36. One or more machine-readable storage media comprising a plurality of instructions stored thereon that, in response to being executed cause an analytics server to:
receive raw data from one or more components of the data center;
retrieve a workbook including one or more analytical algorithms;
analyze the raw data using the one or more analytical algorithms of the workbook;
generate an analytical model for a workload based on the analysis of the raw data;
generate an optimization trigger for one or more components of the data center based on the generated analytical model; and
transmit the optimization trigger to a controller component of the data center.

37. The analytics server of claim 36, wherein the plurality of instructions further cause the analytics server to:
retrieve an infrastructure landscape of the data center used to deploy the workload; and
generate the analytical model for the workload further based on the retrieved infrastructure landscape.

38. The analytics server of claim 36, wherein the plurality of instructions further cause the analytics server to:
retrieve, by the analytics server, one or more previous infrastructure landscapes used to deploy the workload; and
generate the optimization trigger for the data center further based on the one or more previous infrastructure landscapes.

39. The analytics server of claim 36, wherein to retrieve the workbook comprises to retrieve the workbook from a workbook marketplace server, wherein the workbook marketplace server comprises a plurality of workbooks and each of the plurality of workbooks includes one or more different analytical algorithms.

40. The analytics server of claim 39, wherein the plurality of instructions further cause the analytics server to:
generate different analytical models for the data center based on the different analytical algorithms and the workload.

41. The analytics server of claim 40, wherein the plurality of instructions further cause the analytics server to:
generate the optimization trigger for the data center further based on the different analytical models.

42. The analytics server of claim 36, wherein to receive the raw data from the one or more components of the data center comprises to receive the raw data from one or more instrumentation-level components of the data center.

43. The analytics server of claim 42, wherein to receive the raw data from the one or more instrumentation-level components of the data center comprises to receive the raw data from one or more instrumentation-level components from at least one of an infrastructure instrumentation level, a platform instrumentation level, a service instrumentation level, or an application instrumentation level.

44. A method for generating an analytical model for a workload of a data center on an analytics server, the method comprising:
receiving, by the analytics server, raw data from one or more components of the data center;
retrieving, by the analytics server, a workbook including one or more analytical algorithms;
analyzing, by the analytics server, the raw data using the one or more analytical algorithms of the workbook;
generating, by the analytics server, an analytical model for a workload based on the analysis of the raw data;
generating, by the analytics server, an optimization trigger for one or more components of the data center based on the generated analytical model; and
transmitting, by the analytics server, the optimization trigger to a controller component of the data center.

45. The method of claim 44, further comprising:
retrieving, by the analytics server, an infrastructure landscape of the data center used to deploy the workload; and
generating the analytical model for the workload further based on the retrieved infrastructure landscape.

46. The method of claim 44, further comprising:
retrieving, by the analytics server, one or more previous infrastructure landscapes used to deploy the workload; and
generating the optimization trigger for the data center further based on the one or more previous infrastructure landscapes.

47. The method of claim 44, wherein retrieving the workbook comprises retrieving the workbook from a workbook marketplace server, wherein the workbook marketplace server comprises a plurality of workbooks and each of the plurality of workbooks includes one or more different analytical algorithms.

48. The method of claim 47, further comprising:
generating different analytical models for the data center based on the different analytical algorithms and the workload; and
generating the optimization trigger for the data center further based on the different analytical models.

49. The method of claim 44, wherein receiving the raw data from the one or more components of the data center comprises receiving the raw data from one or more instrumentation-level components of the data center.

50. The method of claim 49, wherein receiving the raw data from one or more instrumentation-level components of the data center comprises receiving the raw data from one or more instrumentation-level components from at least one of an infrastructure instrumentation level, a platform instrumentation level, a service instrumentation level or an application instrumentation level.
